(19) United States
(12) Patent Application Publication
(10) Pub. No.: US 2004/0099074 A1
(43) Pub. Date: May 27, 2004

(54) Torque reversing device for circle track racing transmissions

(76) Inventor: Ernie Brookins, West Fargo, ND (US)

Correspondence Address: Curtis V. Harr, P.O. Box 2842, Fargo, ND, 58108-2842, US

(21) Appl. No.: 10/305,535

(22) Filed: Nov. 26, 2002

(51) Int. Cl. F16H 3/08

(52) U.S. Cl. 74/329

(57) ABSTRACT

A torque reversing apparatus which is positioned within the drive train of a circle track race car. The torque reverser is made up of a centrally located gear housing which is most commonly attached to the rear end of the race car's transmission. The forward surface of the gear housing allows for the introduction of the transmission's output shaft which is in turn fixedly attached to the drive gear. The drive gear in turn is meshed with the output gear which is mounted within the gear housing on the same plane as the drive gear. The output gear is in turn fixedly attached to the output shaft of the gear housing which then exits out the rear housing cover where it makes the connection with the drive shaft. Thus, the clockwise rotation of the engine is transformed to a counter clockwise rotation behind the present invention moving the effects of the torque from predominantly being applied to the right side of the vehicle to the left.

### BACKGROUND OF THE INVENTION

The present invention relates to an improvement in the method used to transfer the power generated by an automotive engine to the wheels of the vehicle within which the engine is contained. More specifically, to a method of transferring power to the drive wheels of a circle track race car in a manner which places the torque generated by the rotating components of the drive train on the left side of the race car instead of the right which is the norm in such vehicles today.

The large increase of the popularity of circle track racing has led to increases in the technology employed in the pursuit of faster speeds and coinciding victories at the track. These technologies have primarily focused on the drive train of the vehicles including huge increases in the amount of horsepower developed by the engines, more efficient and effective transmissions and tires which more efficiently apply the power to the race track. While these technological innovations have resulted in improvements in vehicle speeds and lap times, an inherent problem in the drive trains employed in circle track race cars has been overlooked.

All automotive engines used in these applications rotate in a clockwise manner meaning that the linear motion of the engine's pistons and the power generated by this linear motion are transferred to rotational motion and torque by the crankshaft. The clockwise rotation and torque are then transferred to the drive wheels of the vehicle through its drive train, generally consisting of a clutching mechanism to engage and disengage the engine from the drive train when necessary, a transmission to alter the drive ratios between the engine and remaining components of the drive train, a drive shaft to transfer the power from the rear of the transmission to the differential, and the differential which changes the longitudinal (with reference to the body of the vehicle) rotation to a lateral force and also splits it to apply power to both of the drive wheels.

The problem associated with this method of delivering the power to the drive wheels of a circle track race car is that the torque developed within the engine tends to twist not only the relevant components of the drive train but also the body of the vehicle as well due to the fact that the engine is tied to the frame of the vehicle through the engine mounts which leads to the twisting of the body of the race car and exacerbates the loading of its right side. Additionally, the configuration of the majority of circle race tracks (highly banked turns) and the counter clockwise direction of racing places centrifugal forces on the right side of the race car which compounds this weight shifting affect. While intuitively this may seam like a positive outcome, directing the power to the weighted side of the vehicle, actually the reverse is true. This is a problem because on entering a left hand turn the driver lifts off the accelerator which unloads the right rear drive wheel resulting in a vehicle that is loose in the corner. A loose vehicle in a rear wheel drive race car refers to a vehicle whose rear end wants to drift in an opposite direction to the direction that the front of the vehicle is turning. This situation results in spins that can in turn lead to multiple car accidents involving large amounts of property damage and even serious injuries to the drivers participating in the event.

Additionally, while the race teams have come up with numerous mechanical methods to help the vehicle and driver compensate for this affect, it is preferable to have a vehicle setup that is neutral in all parts of the track as compensating for one handling characteristic for a specific section of the race track creates imbalances in other sections of the track. In fact a race car that operates equally well in all sections of a race track is the primary goal of all race teams as such a vehicle would create the greatest opportunity of achieving the best lap times possible and therefore, winning the race. Finally, the components of the vehicle's drive train are also designed to operate at their optimum efficiency when the power is equally distributed between the two drive wheels.

Another common problem in circle track racing is that all the race tracks on the circuits vary to some degree in their configuration. These variances most commonly are manifested in varying lengths of the tracks themselves, the degree of banking in the corners, or differences in the track surfaces. All of these require that the race teams or drivers make adjustments to their vehicle to optimize its performance on any given race track. In the past this commonly involved changing the gear ratios between the engine and the drive wheels so that the engine operated at the proper rpm to develop the maximum amount of horsepower while on the track which is controlled by a number of factors including the length and configuration of a specific track and the type and internal components of the engine being used. The changing of the gear ratios is accomplished by changing out the differential gears or changing the entire rear end to match the track's characteristics. While this is an effective strategy, it is time consuming and expensive as differential gears and rear ends are relatively expensive and difficult to change.

Still another problem associated with the drive trains of circle track race cars is the manner in which the output shaft of the transmission is coupled to the drive shaft or other power transmitting component. This connection is generally accomplished by the machining of a plurality of longitudinally oriented splines around the outer circumference of the most rearward portion of the output shaft. Conversely, the most forward portion of the drive shaft is made of a collar which is equipped with a corresponding number of oppositely oriented splines machined around its inner circumference. The connection is then made by slipping the collar of the drive shaft over the splines of the output shaft in a manner so that the splines of each line up and engage one another. This manner of connection transfers any rotational force in the output shaft of the transmission to the drive shaft and therefore to the drive wheels of the vehicle.

This manner of construction is employed because the nature of the spline connection allows the collar of the drive shaft to slide forwards and rearwards in relation to the transmission without breaking the connection between the two components. This is important to the operation of these vehicles as the suspension travel of the rear end alters the distance between it and the rear of the transmission. The problem associated with this manner of construction stems from the fact that when the output shaft is under load (in other words when the driver is applying the accelerator) the frictional forces created between the splines on the output shaft and those in the collar of the drive shaft is enough to inhibit the free travel of this critical joint. The result of this is that the suspension travel of the rear end of the race car is adversely affected under load which in turn limits the effectiveness of the rear suspension and damages the handling characteristics of the circle track race car when exiting a corner under acceleration. Coincidentally, this is the exact moment during a lap of these tracks which places the highest stress on the rear end and when the greatest amount of grip is required from the drive wheels. Thus, this problem with the typical drive train adversely effects its performance at the worst possible time resulting in slower than optimum lap times and unnecessary stress on the relevant components.

Therefore, it can be seen that it would be advantageous to produce a drive train for circle track race cars that employs the torque generated within its engine to counteract the centrifugal forces inherent in this style of vehicle racing by transferring the weight generating twisting effect from the right side of the vehicle to the left. Additionally, that it would be desirable to provide a means by which the gear ratios of circle track race cars can be quickly and easily changed to best fit the variety of circumstances confronted at different race tracks to optimize the cars performance in a manner that is affordable to even the smallest of operators. Finally, it can also be seen that it would be desirable to design a drive train in which the distance between the rear of the transmission and rear end stays constant regardless of the up and down movement of the rear suspension components.

### SUMMARY OF THE INVENTION

It is the primary objective of the present invention to provide a method by which the torque developed in a circle track race car engine can be employed to transfer weight from the right side of the vehicle and the associated drive wheel to the left side thereby helping to counteract the centrifugal force and the accompanying transfer of weight to the right side of such vehicles as they travel in a counter clockwise manner around the race track thereby resulting in a more even distribution of power between the two drive wheels and providing a more stable and neutral drive platform for these vehicles.

It is an additional objective of the present invention to provide such a means of employing the torque generated within a circle track race engine to stabilize the handling characteristics of the race car by reversing the clockwise rotation of the vehicle's drive train to a counter clockwise rotation which has the effect of applying the engine's torque primarily to the left side of the vehicle.

It is another objective of the present invention to provide such a means of reversing the rotation of a circle track race car's drive train by the use of a mechanism containing a pair of meshed gears at some point of the vehicle's drive train with one of the gears being fixed to the engine's crankshaft or some other component attached thereto and the other counter rotating gear fixed to the differential or other component attached thereto.

It is a further objective of the present invention to provide such a means of reversing the direction of rotation of the drive train components of a circle track race car which also has the affect of stabilizing the distance between the rear end of the transmission and the rear end thereby eliminating the problems associated with the load binding of the splined connection between the output shaft of the transmission and the collar of the drive shaft.

It is a still further objective of the present invention to provide such a means of reversing the direction of rotation of the drive train components of a circle track race car which also contains a means by which the operators of such vehicles can quickly, easily, and inexpensively change the final gear ratio in the transmission to adjust the performance of their vehicle to be more competitive at different race tracks and under differing driving conditions.

These objectives are accomplished by the use of an apparatus which is positioned within the drive train of a circle track race car called a torque reverser. The torque reverser is generally an ovally shaped device being made up of a centrally located gear housing which is most commonly attached to the rear end of the race car's transmission at its forward end and capped off with a cover on its rearward end. The forward surface of the gear housing allows for the introduction of the transmission's output shaft which is in turn fixedly attached to the drive gear. The drive gear in turn is meshed with the output gear which is mounted within the gear housing on the same plane as the drive gear. The output gear is in turn fixedly attached to the output shaft of the gear housing which then exits out the rear housing cover where it makes the connection with the drive shaft. The rotation of the drive gear imparts an opposite rotation to the output gear due to this method of connection which is in turn transferred to the remaining components of the vehicle's drive train. Thus, the clockwise rotation of the engine is transformed to a counter clockwise behind the present invention moving the effects of the torque from predominantly being applied to the right side of the vehicle to the left.

The present invention can be employed within the drive train of a circle track race car in a plurality of different configurations. The first of these is to mount it behind a conventional racing transmission between the transmission's output shaft and the forward end of the vehicle's drive shaft. In this configuration, the forward end of the invention's gear housing is fitted with a spacer housing that serves as the component that is employed to make the required connection. This connection is accomplished by a plurality of bolts that pass forward from the internal face of the spacer housing into existing bolt holes, or visa versa, on the rear face of the transmission. This secures the present invention in the proper orientation with respect to the remaining component of the vehicle's drive train so that the remaining steps of the installation can be easily accomplished. Additionally, the spacer housing provides room within the present invention to accommodate ancillary equipment commonly found on racing transmissions such as an external clutch mechanism. This design feature of the present invention allows for its use with all such transmissions available in the market place today.

The junction between the spacer housing and the gear housing is accomplished through the use of a central spacer whose primary function is to provide a mounting point for a pair of shaft bearings located within the interior of the present invention. The first of these shaft bearings is positioned in the central spacer in line with the Original equipment output shaft of the transmission and functions to support an internal extension of the Original equipment output shaft and to provide a low friction point of securement for it within the body of the present invention. Additionally, the output gear of the present invention is fixedly attached to the counter rotating output shaft whose forward end is secured in a similar manner by a bearing mounted in the central spacer. Finally, the housing cover located on rear of the gear housing also contains a pair of bearings, one of which is in line with the Original equipment output shaft and its related components and serves as a point of low friction mounting for the rearward most ends of these components. The other bearing positioned within the housing cover is in line with the counter rotating output shaft at its point of exit from the body of the present invention and operates to stabilize the central and rearward sections of the counter rotating output shaft.

The housing cover of the present invention is attached to the gear housing by the use of a plurality of bolts which pass through it and into the walls of the gear housing or trough the gear housing and into the housing cover. Additionally, when the present invention is installed on a circle track race car, the housing cover and the associated attachment bolts are freely accessible to the operator. This manner of design allows the operator to quickly remove the housing cover to gain access to the drive and output gears contained therein. This is an important feature of the present invention as it allows the operators of these vehicles to change out the drive and output gears to alter the final gear ration that is supplied to the drive wheels and therefore adjust the performance of the race car to suit different race tracks and driving conditions. A design feature of this aspect of the present invention that further enhances its ease of use is that the drive shaft of the race car does not have to be removed to make this change in the gear ratios. Rather, after removing the bolts that attach the housing cover to the gear housing, the housing cover can be slid rearward because of the splined nature of the connection between the counter rotating output shaft and the drive shaft. This leaves ample room between the housing cover and the gear housing so that the operator can reach in and remove the drive and output gears and replace them with others of differing diameters resulting in an alteration of the gear ratios applied to the drive wheels of the race car.

An additional benefit to the use of the present invention in circle track race cars is that the spacial relationship between the original equipment output shaft and the counter rotating output shaft is such that it allows the angle of the drive shaft in relation to the transmission and rear end of the vehicle to be altered in a manner so the distance between them does not vary regardless of the movement of the rear suspension and drive wheels. This is a result of the fact that the point of origin of the counter rotating output shaft can be varied in relation to the transmission so that it lines up with the point of attachment of the drive shaft at the vehicle's rear end. The result of this configuration is that the splined connection between the counter rotating output shaft and the drive shaft is kept more often in a straight line. The straight line of the drive shaft lessens the angles created in this joint when the rear suspension of the vehicle compresses or expands due to varying loads placed on it by speed or the surface of the track. The lessening of the angles created by this action allows the splined connection between the counter rotating output shaft and the drive shaft to more freely alter their relative positions to one another along the length of the splines regardless of the amount of torque being applied than was possible with previous designs. The reduction of the longitudinal friction of this joint due to the straight line of the drive shaft therefore allows the rear suspension to operate in a freer and more efficient manner which in turn improves the performance of the race car as it circles the race track.

The position of the counter rotating shaft relative to the drive shaft and its connection to the rear end is adjustable by the nature of its connection to the rear of the transmission. This is accomplished through a plurality of sets of possible mounting holes being built into the spacer housing. Each of these sets correspond to the mounting positions of the transmission but the use of differing sets positions the counter rotating output shaft in a different location with respect to drive shaft and its point of attachment to the rear end. To make an adjustment in this position, the user simply chooses the set of mounting holes that results in the optimal relationship with the drive shaft and secures the invention in this position by the use of the appropriate number of mounting bolts.

An additional embodiment of the present invention is also contemplated in which it is utilized as an internal component of a purpose built racing transmission. In this configuration, the drive and output gears are located within the transmission in a position so that the direction of rotation of the counter rotating output shaft is opposite that of the engine. Additionally, the case of this purpose built transmission is constructed in a manner that allows it to be easily split to give the user access to the drive and output gears allowing for the quick and easy alteration of the gear ratios in much the same fashion as described above. Finally, the mounting of this embodiment to the engine is also very similar in that it provides a plurality of mounting hole sets that can be employed to vary the position of the counter rotating output shaft to control the angle of the drive shaft and its connection to the rear end resulting in the same benefits to the performance of the race car as described above.

A further embodiment of the present invention is also contemplated in which the present invention is constructed in a free standing configuration which can be mounted independently in any location between the vehicle's transmission and its rear end or between the engine and transmission. Additionally, in attaching this embodiment of the invention within the vehicle's drive train, it is important to note that it must be secured to its sprung weight (the weight of the vehicle that is carried by its suspension) and not the unsprung weight (the weight contained in the suspension components and rear end) in a similar manner as the engine which is most commonly accomplished by fixedly attaching it to the vehicle's frame. This method of attachment of this embodiment of the present invention ensures that the engine's torque will be applied to shift the weight from the right side of the vehicle to the left.

This embodiment of the invention provides all of the above enumerated benefits to the performance of these vehicles while providing a greater degree of flexibility in its positioning. The primary difference in its operation and installation is that it requires that the mechanism employed to transfer the power from the transmission to the rear end be divided to facilitate the installation. This can be accomplished in a number of ways including using two shorter sections of standard drive shafts in the front and rear of it, using a combination of a solid and jointed shafts, or any other configuration that accomplishes the desired affect.

For a better understanding of the present invention reference should be made to the drawings and the description in which there are illustrated and described preferred embodiments of the present invention.

### DESCRIPTION OF THE DRAWINGS

FIG. 1 is a perspective view of the present invention which illustrates the manner in which it attaches to the rear surface of a standard circle track racing transmission to change the direction of rotation of the output shaft from a clockwise to a counter clockwise manner.

FIG. 2 is a top elevation view of the present invention illustrating its orientation with respect to the transmission and bell housing of a circle track race car.

FIG. 3 is a rear elevation view of the rear surface of a standard racing transmission illustrating the clockwise direction of rotation of the output shaft in the prior art.

FIG. 4 is a rear elevation view of the present invention illustrating the counter clockwise direction of the output shaft resulting from the use of the invention.

FIG. 5 is a cross-sectional view of the present invention taken along line 3 of FIG. 2 which illustrates its manner of internal construction including the location of the drive and output gears and their relative positions with respect to the Original equipment output shaft of the transmission and the counter rotating output shaft of the invention.

FIG. 6 is a rear elevation view of the interior components of the present invention and illustrating the manner in which the drive and output gears are employed to reverse the direction of rotation of the counter rotating output shaft.

FIG. 7 is a rear elevation view of the interior components of the present invention and illustrating the manner in which the size of the drive and output gears can be altered to change the gear ratio of the vehicle's drive train.

FIG. 8 is side elevation view of the present invention illustrating the manner in by which its connecting bolts can be removed to gain access to the interior for the purposes of altering the gear ratios.

FIG. 9 is a side elevation view of the present invention illustrating it as being opened up for access and the manner in which the connection between the counter rotating output shaft and the drive shaft operates to facilitate the altering of the gear ratios.

FIG. 10 is a rear elevation view of the interior of the spacer housing component of the present invention illustrating the manner of construction of the apparatus mounting holes and their orientation with respect to the other major components of the spacer housing.

FIG. 11 is a rear elevation view of the interior of the spacer housing component of the present invention illustrating an alternative set of these apparatus mounting holes being employed to alter the location of the counter rotating output shaft in relation to the related components.

FIG. 12 is a side elevation view of the present invention illustrating the orientation of the vehicle's drive shaft when the invention is properly positioned with respect to the transmission.

FIG. 13 is a perspective view of an alternative embodiment of the present invention in which the torque reversing gears are contained within the body of a purpose built circle track racing transmission.

FIG. 14 is a top elevation view of the alternative embodiment of the present invention of FIG. 13 illustrating the orientation of its major components.

FIG. 15 is a top elevation view of the alternative embodiment of the present invention of FIG. 13 illustrating the manner by which its connecting bolts can be removed to gain access to the interior for the purposes of altering the gear ratios.

FIG. 16 is a top elevation view of the alternative embodiment of the present invention of FIG. 13 illustrating it as being opened up for access and the manner in which the connection between the counter rotating output shaft and the drive shaft operates to facilitate the altering of the gear ratios.

FIG. 17 is a rear elevation view of the alternative embodiment of the present invention of FIG. 13 illustrating its manner of attachment including the use of a plurality of mounting holes for the purposes of altering the final position of the counter rotating output shaft.

FIG. 18 is a side elevation view of a further alternative embodiment of the present invention in which an independent housing is employed giving the invention the ability to be mounted at any point along the vehicle's drive train.

### DESCRIPTION OF THE PREFERRED EMBODIMENT

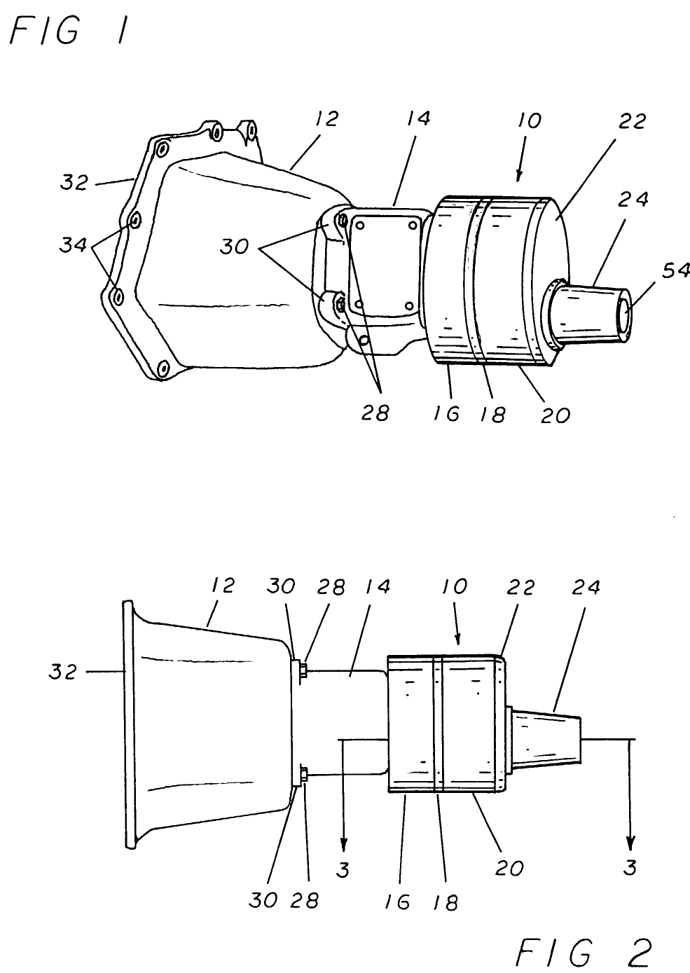

Referring now to the drawings, and more specifically to FIGS. 1 and 2, the torque reverser 10 is attached to the rear surface of racing transmissions 14 that are commonly used in the circle track racing circuits. The racing transmission 14 itself is most often connected to the racing vehicle's engine by the use of a bell housing 12 which is accomplished by the use of a plurality of extending transmission mount tabs 30 located on its forward surface and an equal number of transmission mounting bolts 28 that pass through the transmission mount tabs 30 and into the rear surface of the bell housing 12. The bell housing 12 is in turn connected to the engine by the use of the bell housing flange 32 which is an outwardly extending lip on its forward surface and which is equipped with a plurality of bolt holes 34 to facilitate the attachment.

The most forward end of the torque reverser 10 is made up of a spacer housing 16 which serves to provide a mounting mechanism to attach the present invention to the racing transmission 14 and to provide internal space for ancillary components of the racing transmission 14 that are normally mounted on its most rearward surface. Forward of the spacer housing 16 the central spacer 18 is positioned between the rearward surface of the spacer housing 16 and the forward surface of the gear housing 20. The central spacer's 18 primary function is to serve as the mounting point for a plurality of internal components of the present invention which will be discussed in greater detail below. The gear housing 20 is the component of the invention within which its operational components are contained and it is capped off at its most rearward surface by the housing cover 22. The lower and rearward surface of the housing cover 22 also serves as the mounting point for the shaft sleeve 24 which function to provide protection for the counter rotating output shaft 54 as it exits the body of the invention.

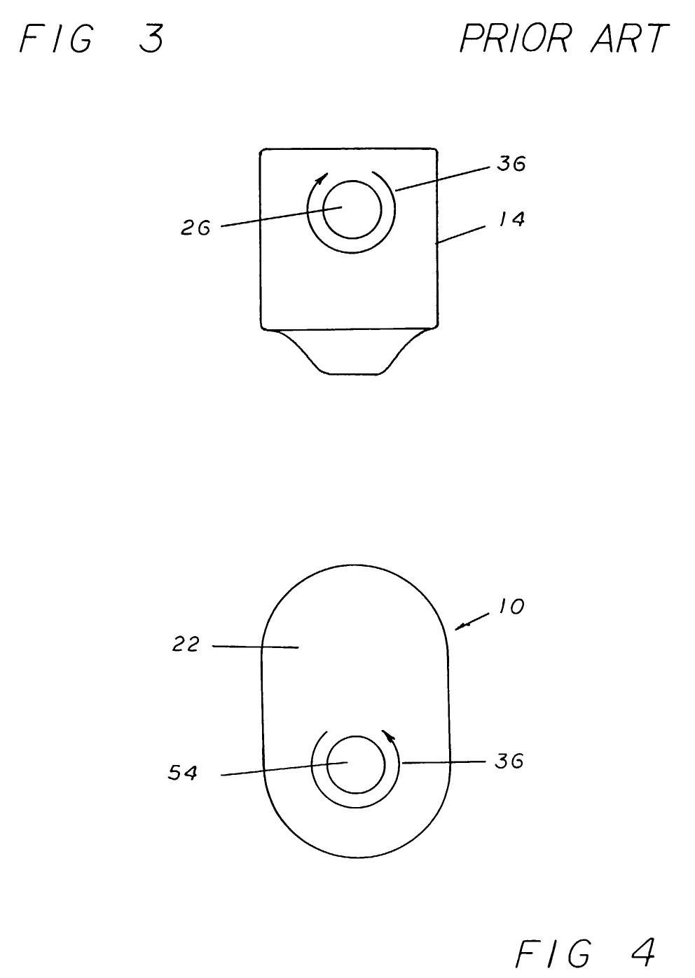

The manner in which the present invention operates to alter the direction of rotation of a circle track race car's drive train is illustrated in FIGS. 3 and 4. In the prior art, the output shaft 26 exited the racing transmission 14 rotating in a clockwise manner as illustrated by shaft rotation arrow 36. Conversely, when the present invention is employed in these applications, the counter rotating output shaft 54 exits the housing cover 22 rotating in a counter clockwise manner as indicated by the shaft rotation arrow 36. This reversing of the rotation of the vehicle's drive train changes the application of the torque generated within the engine from the vehicle's right side to the left which enhances a circle track race car's handling characteristics when running in the corners of the track.

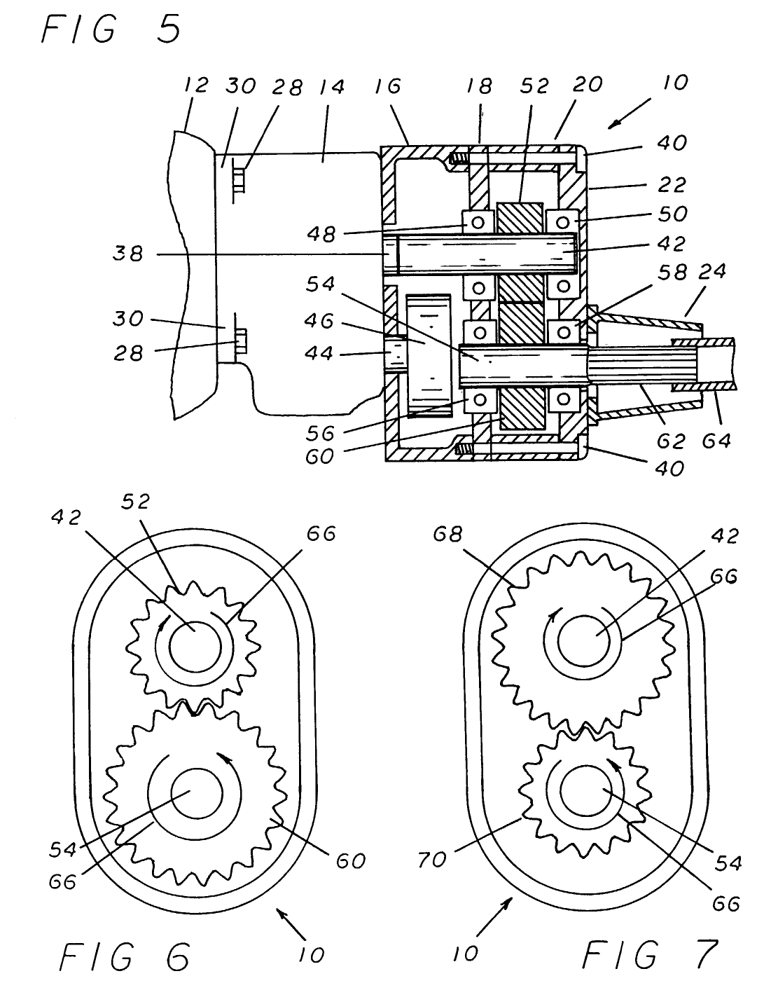

The manner of construction of the internal components of the present invention and their orientation to one another are illustrated in FIG. 5. As the Original equipment output shaft 38 exits the racing transmission 14 it enters the interior of the spacer housing 16. At this point the most rearward end of the Original equipment output shaft 38 is connected to the extension shaft 42 which itself extends rearward through the spacer housing 16, the central spacer 18, and the gear housing 20. Conversely, the original equipment output shaft 38 can also be taken out of the racing transmission 12 and be replaced entirely to accomplish the same thing. The use of the extension shaft 42 allows the rotational power of the Original equipment output shaft 38 to be transmitted to the drive gear 52 located within the interior of the gear housing 20.

The spacer housing 16, the central spacer 18, the gear housing 20, and the housing cover 22 are all held together by the use of a plurality of bolts 72 that pass from the rear of the housing cover 22 forward through the body of the invention by means of a corresponding number of mount bolt holes 40 and which anchor by means of threaded attachments within the rearward surface of the spacer housing 16. This method of attachment provides the operator of the circle track race car with quick and easy access to the interior of the present invention. The quick and easy access to the interior of the invention is important to some aspects of its operation and which will be discussed in greater detail below.

As the extension shaft passes through the central spacer 18, it engages the extension shaft inner bearing 48 at approximately its center point which serves as a low friction point of rotationally mounting the extension shaft 42 to the central spacer 18. Additionally, the most rearward end of the extension shaft 42 is similarly rotationally fixed to the housing cover by the use of the extension shaft outer bearing 50 which is in turn fixed within the body of the housing cover 22. This method of positioning the extension shaft 42 ensures that it will always maintain the proper orientation with respect to the Original equipment output shaft 38 and that it will remain freely rotatable at all times during operation.

The drive gear 52 is fixedly attached to the extension shaft 42 within the gear housing 20 in a manner so that it rotates in conjunction with the Original equipment output shaft 38 and the extension shaft 42. Additionally, the outer edge of the drive gear 52 is meshed with the outer edges of the output gear 60 which is in turn fixedly attached to the forward end of the counter rotating output shaft 54. When rotational force is applied to the drive gear 52 the meshing with the output gear 60 applies an opposite direction of rotation to the output gear 60. The output gear 60 is in turn fixedly attached to the counter rotating output shaft 54 which then transfers the power of the engine to the drive shaft spline 64 connected to its rearward most end. Thus, the mechanism employed to reverse the direction of the rotation of the vehicle's drive train is the simple interaction of the drive and output gears, 52 and 60.

The counter rotating output shaft 54 is rotationally attached within the gear housing 20 at its forward end to the central spacer 18 by the use of the output shaft inner bearing 56. From this point the counter rotating output shaft 54 extends rearward to pass through the housing cover 22 where it is again rotationally attached by the use of the output shaft outer bearing 58. From the point of exit from the housing cover 22, the counter rotating output shaft 54 passes through the shaft sleeve 24. The shaft sleeve 24 serves to protect the portion of the counter rotating output shaft 54 that is equipped with the output splines 62 which are a plurality of longitudinally oriented ridges and grooves machined to mate with an oppositely configured longitudinally oriented series of ridges and grooves located on the inner surface of the drive shaft spline 64. This manner of connecting the counter rotating output shaft 54 to the remaining components of the vehicle's drive train allows their relative position to one another to change without affecting the transmission of power from the vehicle's engine to the rear drive wheels.

As previously stated, one of the functions of the spacer housing 16 is to provide space for the incorporation of ancillary components that may or may not be attached to the rear surface of the racing transmission 14. For the purposes of illustration, FIG. 5 depicts such a situation in which an external clutch assembly 46 is mounted to an original equipment counter shaft 44 extending from the rear of the racing transmission 14. The clutch assembly 46 fits easily within the interior of the spacer housing 16 and so the use of the present invention with this type of configuration does not affect the operation of the racing transmission 14. Also it must be noted that the lack of such ancillary components does not effect the operation of the present invention so there are not alterations to its configuration that are necessary for its proper operation.

The manner in which the drive and output gears, 52 and 60, operate to alter the direction of rotation and the effect of changing the gear ratios are illustrated in FIGS. 6 and 7. The extension shaft 42 is fixedly attached to the drive gear 52 and rotates in a clockwise manner as indicated by the gear rotation arrow 66. Conversely, the counter rotating output shaft 54 is fixedly attached to the output gear 60 which is in turn positioned and configured in a manner so that the lower surface of the drive gear 52 and the upper surface output gear 60 mesh together. Thus, the clockwise rotation of the drive gear 52 forces the output gear 60 in a counter clockwise direction as indicated by the gear rotation arrow 66. This counter clockwise rotation is then transferred to the counter rotating output shaft 54.

The present invention also provides a mechanism by which the operator of a circle track race car can quickly and easily alter the gear ratio provided to the drive wheels. This is accomplished by removing the drive and output gears, 52 and 60, with an optional set of gears of differing outside diameters. Thus, in FIG. 6 the drive gear 52 is of a relatively small diameter and the output gear 60 is of a relatively large diameter. This configuration is referred to as a low gear ratio and is used primarily at shorter tracks where the top speeds attained are comparatively slow because the use of a low gear ratio keeps the engine revving at higher rpms which in turn generates more horsepower. Conversely, FIG. 7 illustrates the use of the high drive gear 68 which is relatively large in diameter and a high output gear 70 which is relatively small in diameter. This configuration is commonly referred to as an overdrive setup and is employed in longer tracks where high top end speeds are extremely important. The rotation reversing affect of the meshing of the gears functions in the same manner so that the altering of the gear ratios in this manner has no effect on the operation of the present invention.

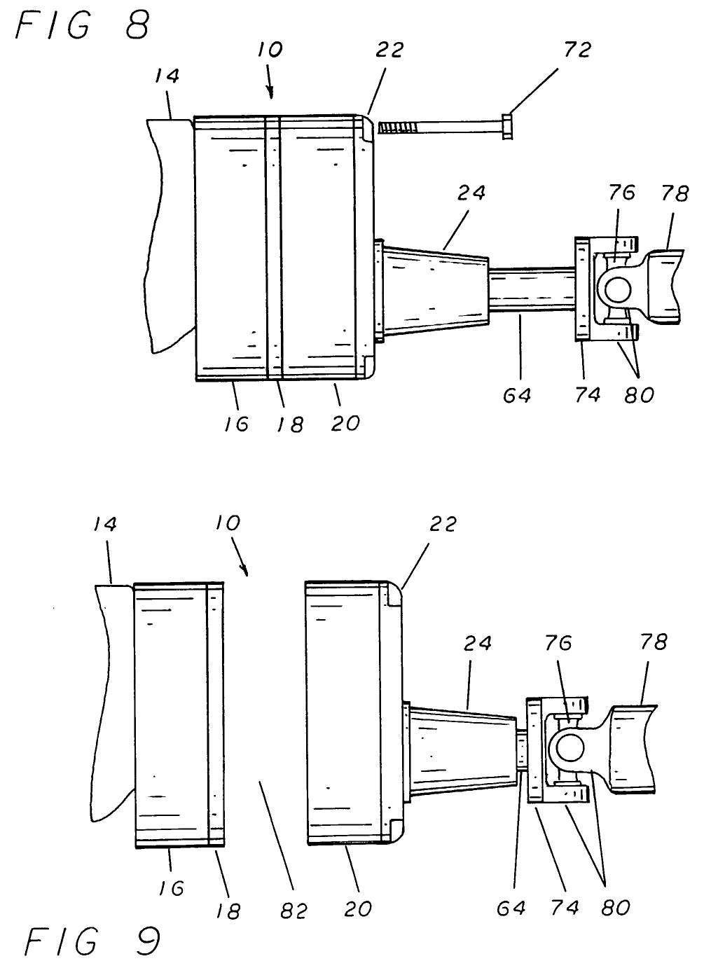

The process that is employed to make these changes to the gear ratios is illustrated in FIGS. 8 and 9. Access is gained to the interior of the present invention by first removing the plurality of bolts 72 that connect the gear housing 20 to the central spacer 18 and the spacer housing 16. Once this has been accomplished, the gear housing 20 and housing cover 22 are slid in a rearward manner creating the quick-change access gap 82. This allows the operator to reach in and change out the drive and output gears, 52 and 60, to fit the encountered circumstances.

These FIGURES also illustrate the manner in which the connection between the counter rotating output shaft 54 and the drive shaft spline 64 facilitates this operation. The splined nature of this connection allows the counter rotating output shaft 54 and its related components to slide rearward within the drive shaft spline 64 to open up the quick-change access gap 82 without having to remove the drive shaft 78. Additionally, the design of the forward portion of the drive shaft 78 allows the separated gear housing 20 to be angularly displaced from the line between the spacer housing 16 and the drive shaft 78 which provides a further degree of access to the interior of the gear housing 20. The forward portion of the drive shaft 78 contains two forward extending U-joint housings 80 having a centrally located gap between them and which terminate just forward of this position. At a right angle to the plane defined by these U-joint housings 80 are another pair which begin just forward of the body of the drive shaft 78 and are attached at their forward ends to the drive shaft flange 74 which is in turn attached to the most rearward end of the drive shaft spline 64. Finally, the space between the U-joint housings 80 is spanned by a U-joint 76. This configuration creates a flexible joint between the drive shaft 78 and the drive shaft spline 64 and allows for the aforementioned angular displacement of the detached gear housing 20 making it easier for the operator to making the desired change to the gear ratios of the drive train.

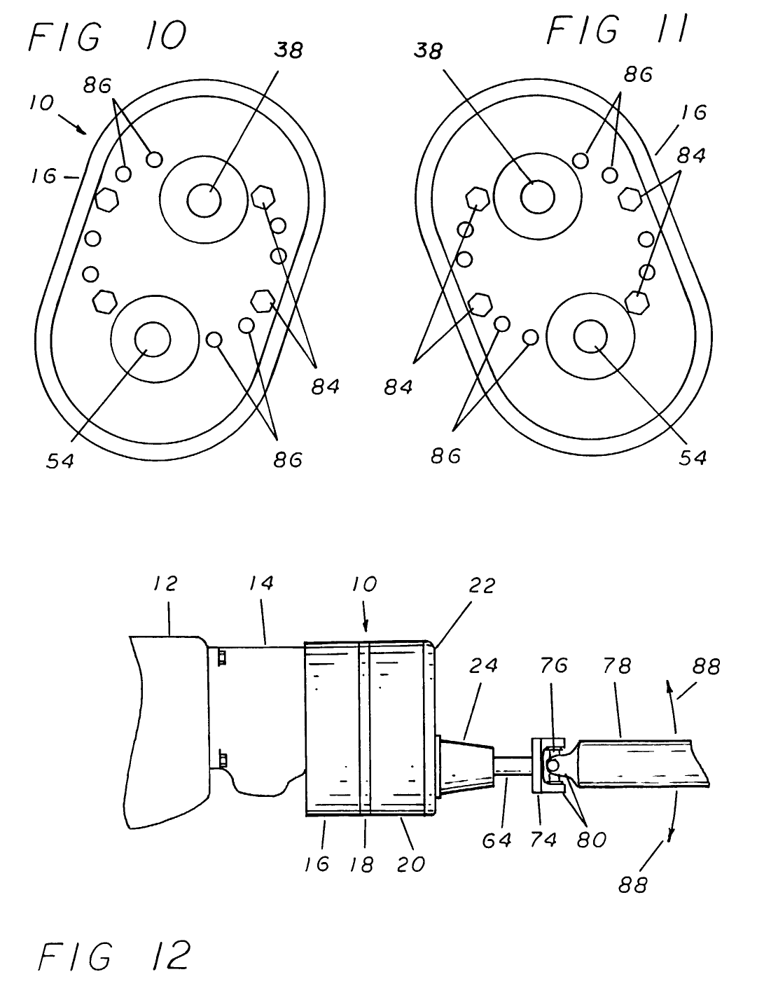

The manner by which the spacer housing 16, and therefore the remaining components of the present invention, is attached to the racing transmission 14 is further detailed in FIGS. 10 and 11. The interior of the spacer housing 16 is equipped with a plurality of apparatus mount holes 86 which are employed in matching sets which correspond in location and configuration to the mounting holes located on the rearward surface of the racing transmission 14. When the set of apparatus mount holes 86 have been properly lined up with the racing transmission 14, a corresponding number of apparatus mount bolts 84 are passed through the spacer housing 16 to secure the present invention in place. The unused apparatus mount holes 86 are there to allow the spacer housing 16 to be mounted in a plurality of different positions which allows the operator to control the relative position of the counter rotating output shaft 54 in relation to the Original equipment output shaft 38.

The purpose for the multiple mounting position capability is further detailed in FIG. 12 which illustrates the effect of a properly positioned counter rotating output shaft 54. When the line defined by the longitudinal axis of the counter rotating output shaft 54 and the drive shaft 78 is as straight as possible the frictional forces placed on the joint between the drive shaft spline 64 and the counter rotating output shaft 54 is greatly reduced allowing these components to slide back and forth in relation to one another with a greater degree of freedom. This is true even when the drive shaft 78 changes its position due to the action of the rear suspension; a situation that is illustrated by the drive shaft movement arrows 88 in this FIGURE. The freedom of movement afforded to the drive shaft spline 64 of this manner of design allows the rear suspension to operate more effectively than was previously possible because the prior binding of the joint would not allow the drive shaft 78 to easily move in relation to the rear of the racing transmission 14. This restriction of movement interfered with the operation of the rear suspension which in turn adversely affected the performance of the vehicle to which it was attached.

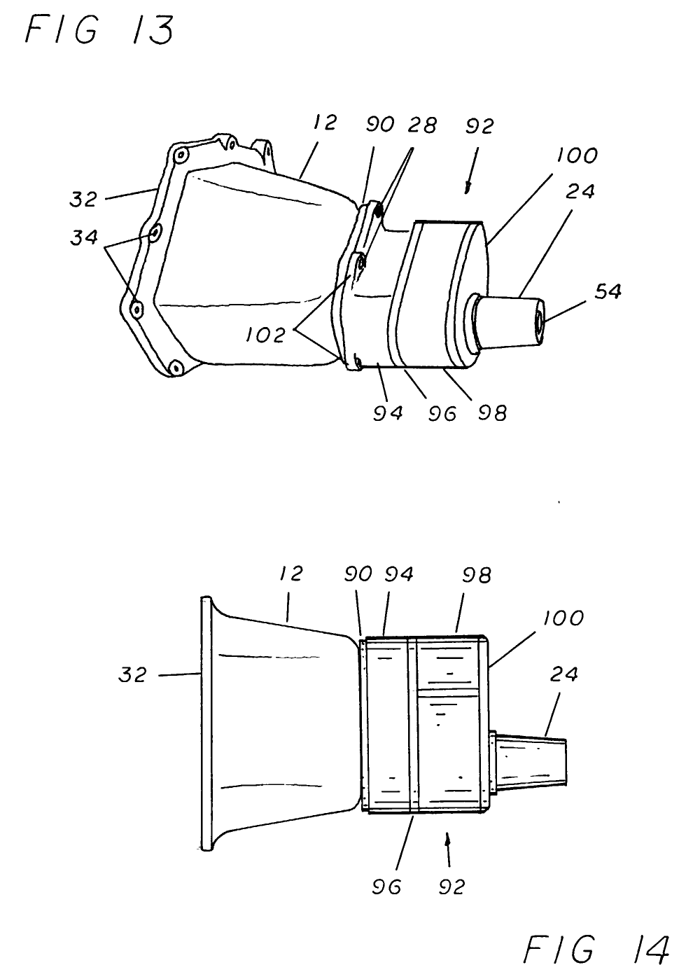

An alternative embodiment of the present invention is illustrated in FIGS. 13 and 14 which detail the use of a purpose built torque reversing transmission 92 incorporating the drive and output gears, 52 and 60, of the previous embodiment into its body. The torque reversing transmission 92 itself is most often connected to the racing vehicle's engine by the use of a bell housing 12 which is accomplished by the use of a plurality of extending transmission mount holes 102 located on its forward surface and an equal number of transmission mounting bolts 28 that pass through the transmission mount holes 102 and into the transmission mount plate 90 which is in turn mounted to the bell housing 12. The transmission mount plate 90 is used here for illustrative purposes and may be altered or removed entirely in differing applications depending on the nature of construction of the relevant components. The bell housing 12 is in turn connected to the engine by the use of the bell housing flange 32 which is an outwardly extending lip on its forward surface and which is equipped with a plurality of bolt holes 34 to facilitate the attachment.

The torque reversing transmission 92 is comprised at its forward end by the forward gear housing 94 which houses the operational components of the present invention, the transmission mount flange 96 which is located directly behind the forward gear housing 94 and serves to provide the means by which the transmission housing 98 is mounted to the forward gear housing 94 and therefore the bell housing 12, the transmission housing 98 which encases the operational gear changing components of the torque reversing transmission 92, the transmission cover 100 (which may be cast as part of the transmission housing 98) which closes off the rearward most surface of the transmission housing 98, and the shaft sleeve 24 protection the protruding portion of the counter rotating output shaft 54. The primary advantage offered by this embodiment of the present invention is compactness by allowing for the a more efficient use of the available space in the design and construction of a circle track race car.

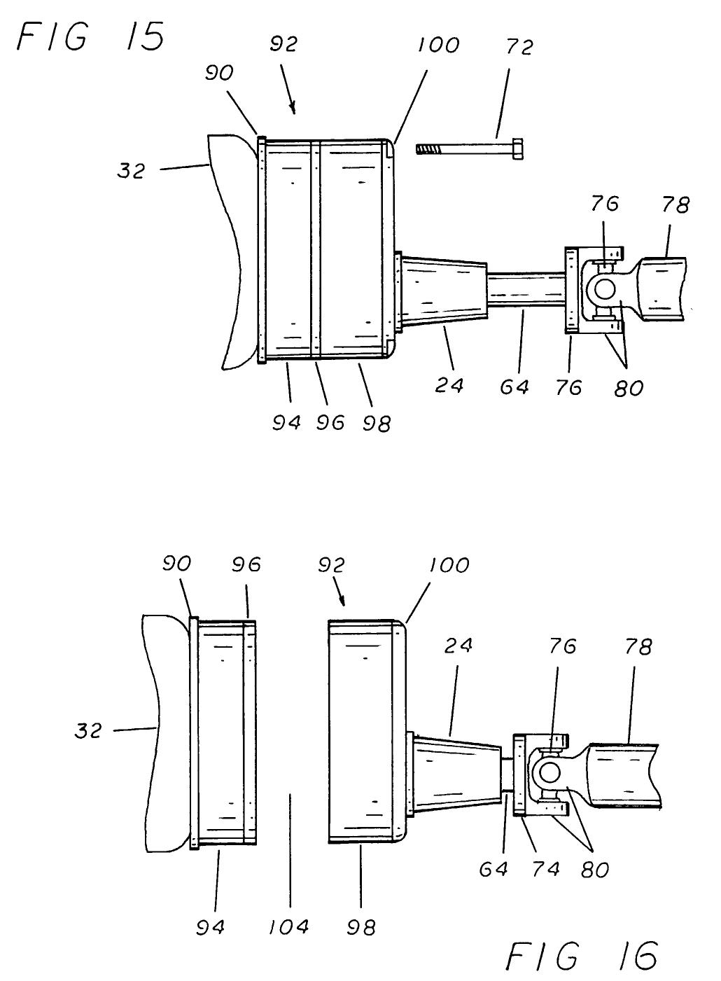

This embodiment of the present invention also offers the ability to change out the gear ratios in a quick and efficient manner, the process of which is illustrated in FIGS. 15 and 16. Access is gained to the interior of the this embodiment of the present invention by first removing the plurality of bolts 72 that connect the transmission housing 98 to the transmission mount flange 96 and the forward gear housing 94. Once this has been accomplished, the transmission housing 98 and transmission cover 100 are slid in a rearward manner creating the transmission access gap 104. This allows the operator to reach in and change out the drive and output gears, 52 and 60, to fit the encountered circumstances. Another important point related to this capability of the present invention is that the operation of the drive and output gears, 52 and 60, original equipments not require the use of a lubricant so there is no need to drain and refill the gear housing 20 every time this procedure is performed.

These FIGURES also illustrate the manner in which the connection between the counter rotating output shaft 54 and the drive shaft spline 64 facilitates this operation. The splined nature of this connection allows the counter rotating output shaft 54 and its related components to slide rearward within the drive shaft spline 64 to open up the transmission access gap 10 without having to remove the drive shaft 78. Additionally, the design of the forward portion of the drive shaft 78 allows the separated transmission housing 98 to be angularly displaced from the line between the forward gear housing 94 and the drive shaft 78 which provides a further degree of access to the interior of the forward gear housing 94. The forward portion of the drive shaft 78 contains two forward extending U-joint housings 80 having a centrally located gap between them and which terminate just forward of this position. At a right angle to the plane defined by these U-joint housings 80 are another pair which begin just forward of the body of the drive shaft 78 and are attached at their forward ends to the drive shaft flange 74 which is in turn attached to the most rearward end of the drive shaft spline 64. Finally, the space between the U-joint housings 80 is spanned by a U-joint 76. This configuration creates a flexible joint between the drive shaft 78 and the drive shaft spline 64 and allows for the aforementioned angular displacement of the detached transmission housing 98.

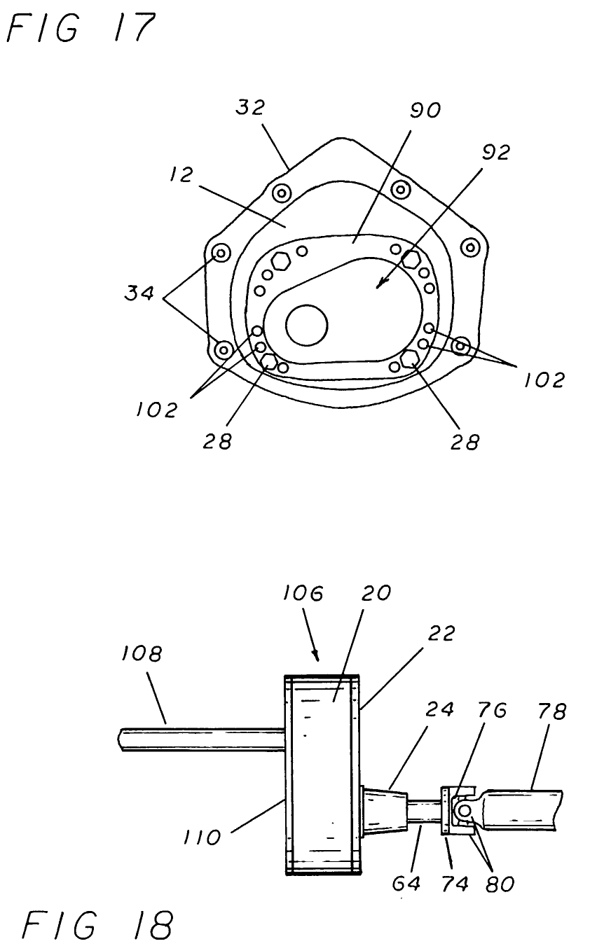

The manner by which the transmission mount plate 90, and therefore the remaining components of the torque reversing transmission 92, is attached to the bell housing 12 is further detailed in FIG. 17. The transmission mount plate 90 is equipped with a plurality of transmission mount holes 102 which are employed in matching sets which correspond in location and configuration to the mounting holes located on the rearward surface of the bell housing 12. When the set of transmission mount holes 102 have been properly lined up with the bell housing 12, a corresponding number of transmission mount bolts 28 are passed through the transmission mount plate 90 to secure this embodiment of the present invention in place. The unused transmission mount holes 102 are there to allow the transmission mount flange 90 to be mounted in a plurality of different positions which allows the operator to control the relative position of the counter rotating output shaft 54 in relation to the Original equipment output shaft 38. Thus, this embodiment of the present invention is equipped with a mechanism which allows the operator to affect the position of the drive shaft and provides the same associated benefits as described above.

A further alternative embodiment of the present invention is illustrated in FIG. 18 which details the manner of construction of the independent torque reverser 106. The independent torque reverser 106 is essentially the operational components of the previously described embodiments of the present invention but configured in a manner that allows it to be mounted at any position within the drive train of the circle track race car. It is important to note that in the mounting of this embodiment of the present invention it must be secured to its sprung weight (the weight of the vehicle that is carried by its suspension) and not the unsprung weight (the weight contained in the suspension components and rear end) in a similar manner as the engine which is most commonly accomplished by fixedly attaching it to the vehicle's frame. This method of attachment of this embodiment of the present invention ensures that the engine's torque will be applied to shift the weight from the right side of the vehicle to the left.

The independent torque reverser 106 is comprised of a front housing cover 110 covering the most forward portion of the gear housing 20 which in turn has its most rearward surface covered by the housing cover 22 as with the previous embodiments. A significant difference in this embodiment is the rotational power of the engine is delivered to it by an exposed shaft here illustrated as being a solid shaft 108 but it is important to note that this function could be accomplished by any number of means including an additional drive shaft. In all other aspects of the operation of this embodiment of the present invention it operates as previously described for the previous embodiments. The advantage offered by this embodiment of the present invention is that it allows an operator of a circle track race car to position a drive train rotation reversing device in any location in the drive train that he desires. This may provide easier access to the unit and facilitate a quicker gear ratio changing operation or be more accommodating to his mechanical or financial resources.

Although the present invention has been described in considerable detail with reference to certain preferred versions thereof, other versions are possible. Therefore, the spirit and scope of the appended claims should not be limited to the description of the preferred versions contained herein.

What is claimed:

1. An automotive torque reverser for use on a car having a engine and transmission said torque reverser comprising:
a torque reverser housing;
an extension shaft having a drive gear mounted to said extension shaft;
a counter rotating output shaft having a output gear mounted to said counter rotating output shaft said output gear being meshed with said drive gear such that said output gear and said counter rotating output shaft rotate in a reverse direction of said drive gear and said extension shaft.

2. An automotive torque reverser as in claim 1 further comprising an extension shaft inner and outer bearing and a counter rotating output shaft inner and outer bearing.

3. An automotive torque reverser as in claim 2 wherein said torque reverser is mounted to the back of said transmission, through a plurality of fasteners.

4. An automotive torque reverser as in claim 2 wherein said torque reverser is mounted between said car engine and said transmission.

5. An automotive torque reverser as in claim 2 wherein said torque reverser is mounted to said car behind said transmission such that a drive shaft section connects said transmission to said torque reverser.

6. A engine driven vehicle having a motor with a clockwise turning crank shaft connected to a transmission having a plurality of forward drive gears and a transmission output shaft said engine driven vehicle further comprising:
a torque reverser connected to said transmission output shaft wherein said transmission output shaft turns in a clockwise direction when said motor is turning and said transmission has engaged one of said forward drive gears;
a torque reverser gear housing having a first and second side;
an extension shaft extending out of said first side of said gear housing and connecting to said transmission output shaft said extension shaft having a drive gear mounted to said extension shaft;
a counter rotating output shaft extending out of said second side of said gear housing and connecting to a drive shaft, said counter rotating output shaft having an output gear mounted to said counter rotating output shaft said output gear being meshed with said drive gear such that said output gear and said counter rotating output shaft rotate in a reverse direction of said drive gear and said extension shaft.

7. An engine driven vehicle as in claim 6 further comprising an extension shaft inner and outer bearing and a counter rotating output shaft inner and outer bearing.

8. An engine driven vehicle as in claim 7 wherein said torque reverser is mounted to the back of said transmission through a plurality of fasteners.

9. An engine driven vehicle as in claim 8 wherein said counter rotating output shaft is connected to a drive shaft.

10. An engine driven vehicle as in claim 9 wherein said torque reverser further comprising a spacer housing attached to said first side of said torque reverser gear housing so as to form a compartment between said transmission and said torque reverser housing.

11. An engine driven vehicle as in claim 10 wherein said spacer housing defines a plurality of mounting holes such that various combinations may be used to mount said torque reverser relative to said transmission.

12. An engine driven vehicle as in claim 7 wherein said torque reverser is mounted to said car behind said transmission such that a drive shaft section connects said transmission output shaft to said torque reverser.

13. A engine driven vehicle having a motor with a clockwise turning crank shaft and a bell housing, a transmission having a plurality of forward drive gears and a transmission output shaft said engine driven vehicle further comprising:
a torque reverser connecting said motor bell housing to said transmission such that said transmission output shaft turns in a counter-clockwise direction when said motor is turning and said transmission has engaged one of said forward drive gears;
a torque reverser gear housing having a first and second side;
an extension shaft extending out of said first side of said torque reverser gear housing into said bell housing and a drive gear mounted to said extension shaft;
a counter rotating output shaft extending out of said second side of said gear housing and connecting to said transmission, said counter rotating output shaft having an output gear mounted to said counter rotating output shaft said output gear being meshed with said drive gear such that said output gear and said counter rotating output shaft rotate in a reverse direction of said drive gear and said extension shaft.

14. An engine driven vehicle as in claim 13 further comprising an extension shaft inner and outer bearing and a counter rotating output shaft inner and outer bearing.

15. An engine driven vehicle as in claim 14 wherein said transmission has an output shaft connected to a drive shaft and said output shaft and said drive shaft rotate in a counterclockwise direction when said transmission has an engaged forward drive gear.
